(19) United States
(12) Patent Application Publication
(10) Pub. No.: US 2006/0269230 A1
(43) Pub. Date: Nov. 30, 2006

(54) Method for randomly reproducing audio files

(75) Inventor: Chung Bum Cho, Osan-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/436,604

(22) Filed: May 19, 2006

(30) Foreign Application Priority Data
May 19, 2005 (KR) 10-2005-0042014
May 20, 2005 (KR) 10-2005-0042343

(51) Int. Cl. H04N 7/00

(52) U.S. Cl. 386/95

(57) ABSTRACT

A random play method including selecting an arbitrary file to be played from a playlist, playing the arbitrary file, and selecting a next arbitrary file to be played from the playlist while skipping the played arbitrary file until all files in the playlist have been played.

This application claims priority to Korean Patent Applications No. 10-2005-0142014 and No. 10-2005-042343 filed on May 19 and 20, 2005, respectively in Korea, the entire contents of which is hereby incorporated by reference in its entirety.

### BACKGROUND OF THE INVENTION

1. Field of the Invention

The present invention relates to a random play method, and more particularly to a method for efficiently performing a random play operation of a number of titles recorded on a recording medium.

2. Description of the Related Art

High-capacity optical discs such as CD-R and DVD-R/+R discs and recording/playback devices thereof are widely used. As flash memories have increased in capacity and decreased in price due to development of semiconductor technologies, portable playback devices using flash memories have become widespread. Also, as hard disks and related storage media have increased in capacity and decreased in price and power consumption, they have become widely used not only in standalone type playback devices, but also in portable type playback devices.

Further, multimedia players that play MPEG videos, mp3 files, or the like can store a large amount of multimedia data using such high-capacity storage media. Users of such multimedia players, particularly portable or in-vehicle multimedia players, often move, drive, or work while sequentially or randomly playing a number of mp3 files stored on the high-capacity storage media.

In addition, general multimedia players randomly select a title to play from all titles which have been requested to be randomly played, determine whether or not the selected title has already been played, and repeat the process of randomly selecting a title to play from all the titles when the selected title has already been played. Accordingly, the number of times the selecting process is repeated greatly increases with an increase in the number of titles requested to be randomly played. In addition, the number of times the selection process is repeated increases even more with an increase in the number of titles that have already been played. This increases the time required to select a title which has not been played and also increases the power consumption due to repetition of unnecessary operations.

### SUMMARY OF THE INVENTION

Accordingly, one object of the present invention is to address the above and other noted problems

Another object of the present invention to provide a random play method that rapidly selects a title that has not yet been played.

To achieve these and other advantages and in accordance with the purpose of the present invention, as embodied and broadly described herein, the present invention provides a random play method including selecting an arbitrary file to be played from a playlist, playing the arbitrary file, and selecting a next arbitrary file to be played from the playlist while skipping the played arbitrary file until all files in the playlist have been played.

According to another aspect, the present invention provides a random play apparatus including a controller configured to select an arbitrary file to be played from a playlist, and a decoder configured to play the arbitrary file, wherein the controller selects a next arbitrary file to be played from the playlist while skipping the played arbitrary file until all files in the playlist have been played.

In yet another aspect, the present invention provides a random play method including generating a first playlist of files to be played, playing an arbitrary file among the first playlist, and generating a new playlist excluding the played arbitrary file.

In still another aspect, the present invention provides a random play apparatus including a controller configured to generate a first playlist of files to be played, and a decoder configured to play an arbitrary file among the first playlist. Further, the controller generates a new playlist excluding the played arbitrary file

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, wherein:

FIG. 1 is a block diagram of an audio device in accordance with an embodiment of the present invention;

FIG. 2 is a flow chart of a random play method in accordance with an embodiment of to the present invention;

FIGS. 3 and 4 are diagrams illustrating a random play process in accordance with an embodiment of the present invention;

FIG. 5 is a flow chart of a random play method in accordance with another embodiment of the present invention; and

FIG. 6 is a diagram illustrating a random play process in accordance with an embodiment of the present invention.

### DETAILED DESCRIPTION OF PREFFERRED EMBODIMENTS

Preferred embodiments of a random play method according to the present invention will now be described in detail with reference to the accompanying drawings.

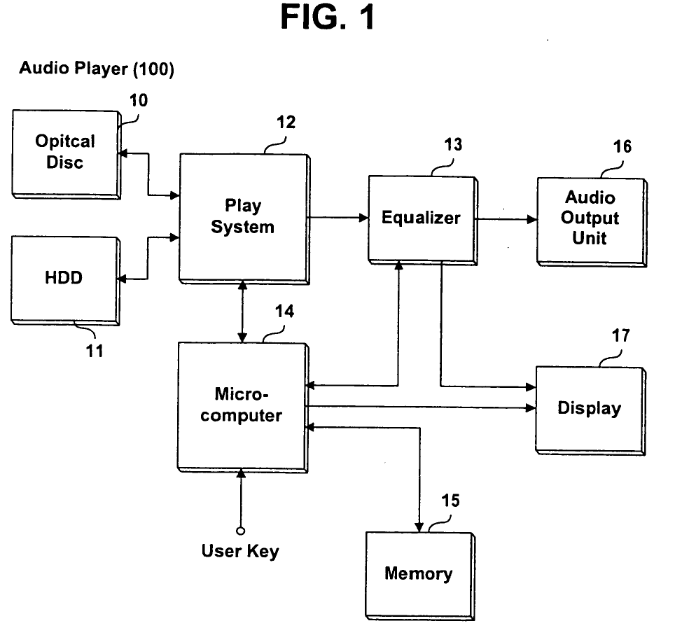

FIG. 1 is block diagram of an audio device in accordance with an embodiment of the present invention. As shown in FIG. 1, a multimedia player such as an audio player for playing pieces of audio music (for example, mp3 files) includes various types of recording media such as an optical disc 10 or a hard disk drive 11, a play system 12 such as a decoder, an equalizer 13, a microcomputer 14, a memory 15, an audio output unit 16, and a display 17.

At the request of the user, the microcomputer 14 controls the operation of the play system 12 to read and play audio music recorded on the optical disc 10 or the hard disk drive 11. Further, the microcomputer 15 reads navigation information recorded on a specific area such as a lead-in area of the optical disc 10, stores the read navigation information in the memory 15, and plays audio music recorded on the optical disc 10 with reference to the navigation information. The microcomputer 14 also plays audio music recorded on the hard disk drive 11 with reference to navigation information recorded in a File Allocation Table (FAT) of the hard disk drive 11.

Further, at the request of the user, the microcomputer 14 performs a random play operation to randomly select and play a piece of audio music from a number of pieces of audio music recorded on the recording medium such as the optical disc 10 or the hard disk drive 11.

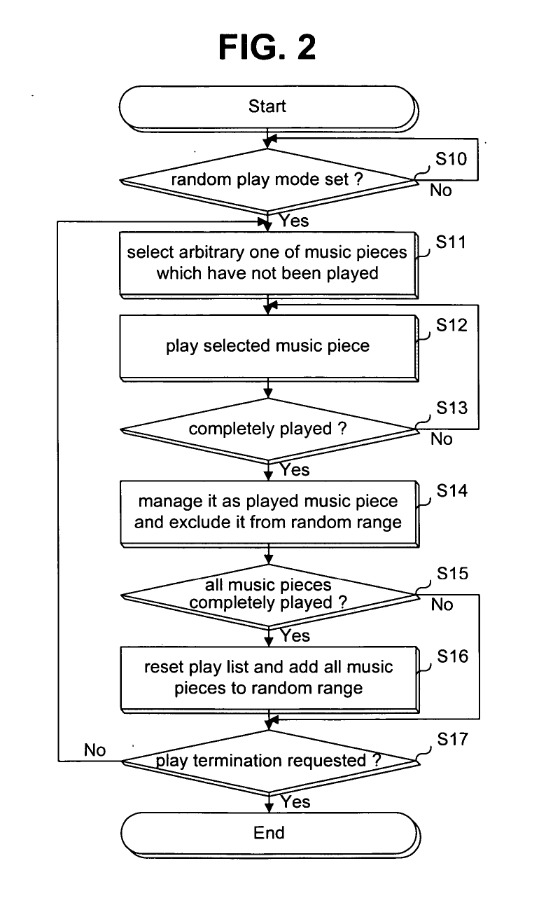

Turning now to FIG. 2, which is a flow chart of a random play method in accordance with an embodiment of the present invention. An example of the random play method is described below with reference to audio music, because random play of audio files is generally more common than that of moving images. Further, elements shown in FIG. 1 will also be used in the description of FIG. 2.

When the user sets a random play mode for a number of titles (for example, n pieces of audio music) recorded on a recording medium such as the optical disc 10 (Yes in S10), the microcomputer 14 randomly selects one of a plurality of pieces of audio music, which has not been played, from among the n pieces of audio music that have been requested to be randomly played (S11).

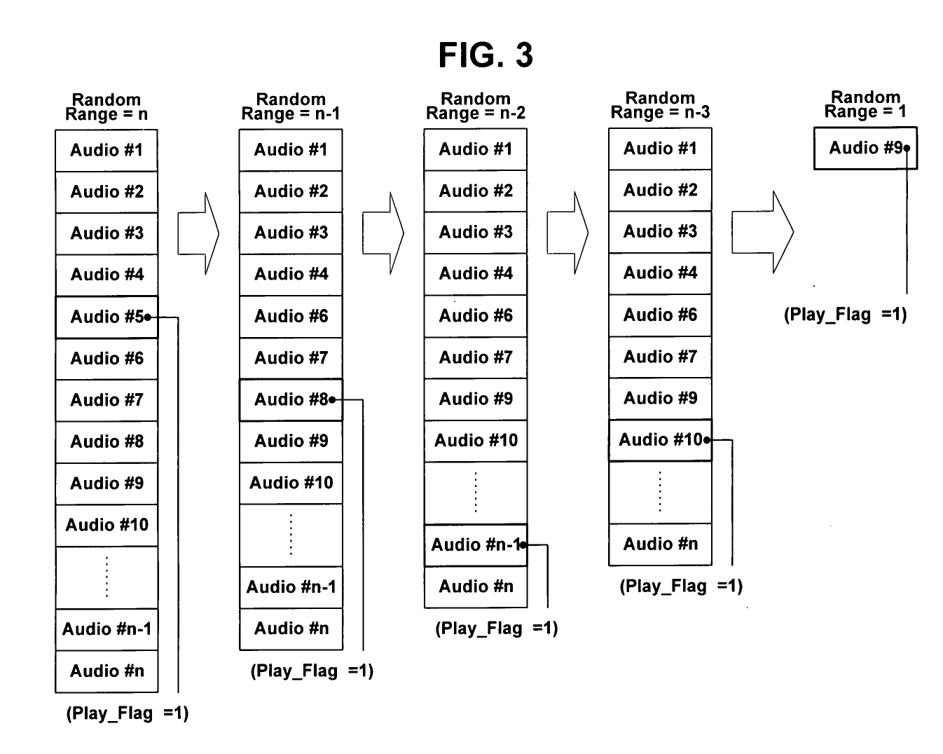

In this embodiment, the microcomputer 14 sets an identifier (for example, a play flag “Play_Flag”) of one or more bits indicating whether or not the corresponding piece of audio music has been played. For example, the play flag is set to “1” for each piece of audio music that has already been randomly selected and played. The piece of audio music with the play flag “1” is then excluded from a range of random selection targets (also referred to as a “random range”). In more detail, as shown in FIG. 3, when a piece of audio music has been selected and played, its play flag is set to “1,” and this piece of audio music with the play flag “1” is excluded from the next random range. For example, when k pieces of audio music have been played, the microcomputer 14 selects an arbitrary one of the n−k pieces of audio music with play flags “0” at the above step S11.

The microcomputer 14 then plays the selected piece of audio music (S12). When the selected piece of audio music has been completely played (Yes in S13), the microcomputer 14 sets its play flag to “1,” stores the play flag in the memory 15, and then excludes the piece of audio music with the play flag “1” from the next random range (S14).

Thereafter, the microcomputer 14 determines whether or not all of the requested pieces of audio music recorded on the optical disc 10 have been completely played (S15). When all of the requested audio pieces have been completely played (Yes in S15), the microcomputer 14 clears the play flags in the memory 15 of all the requested audio pieces to “0” so that all the pieces of audio music again become random selection targets (S16), and again performs the random play operation. Further, the random play operation is continued until the user requests the play operation be terminated (S17).

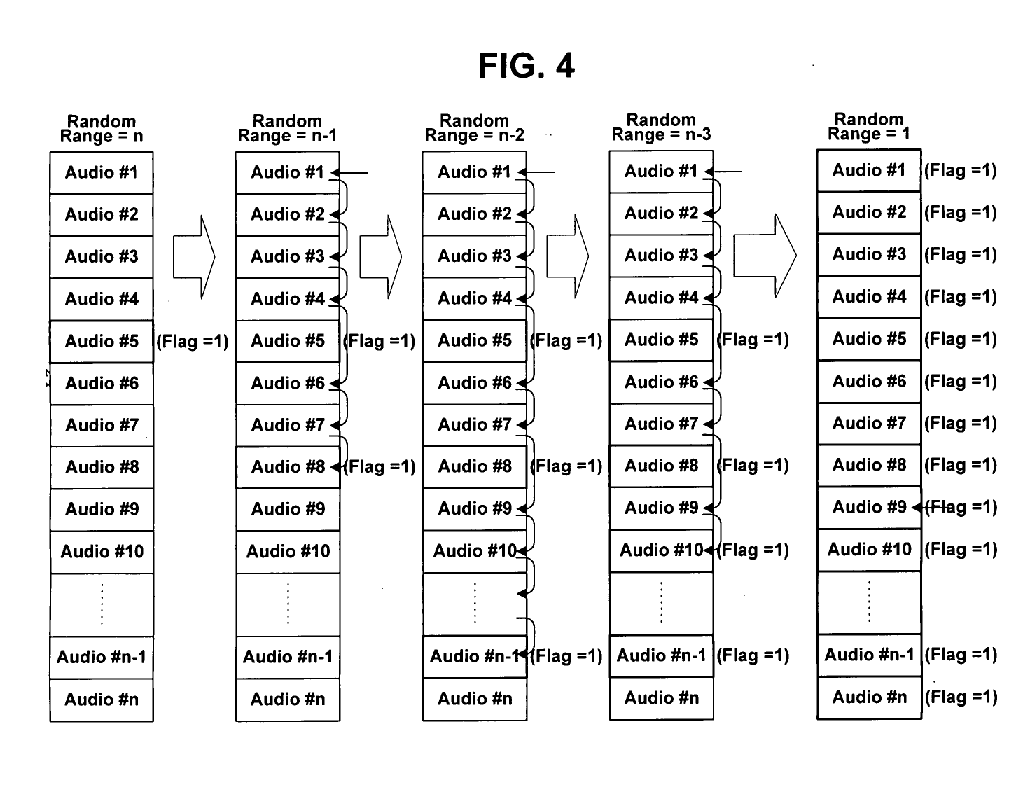

Another method for randomly selecting one of the n−k pieces of audio music other than the k pieces of audio music already played will now be described with reference to FIG. 4. For example, a random play operation for n pieces of audio music (Audio #1-#n) recorded on the optical disc 10 is performed in the following manner. The microcomputer 14 randomly selects a 5th piece of audio music (Audio #5) as the first piece of audio music to play from the n pieces of audio music and plays the 5th piece of audio music (Audio #5). The microcomputer 14 then sets a play flag of the 5th audio music (Audio #5) to “1” and stores the play flag in the memory 15.

The microcomputer 14 then generates a random value with reference to the number (n−1) of the pieces of audio music which have not been played other than the 5th piece of audio music (Audio #5) whose play flag has been set to “1.” For example, when the generated random value is 7, the microcomputer 14 counts the pieces of audio music sequentially from the 1st piece of audio music (Audio #1) to locate a seventh piece of audio music while skipping the 5th piece of audio music (Audio #5) whose play flag has been set.

The microcomputer 14, selects and plays an 8th piece of audio music (Audio #8) corresponding to the seventh piece of audio music located by skipping the 5th piece of audio music (Audio #5) whose play flag has been set to “1,” and then sets a play flag of the eighth piece of audio music (Audio #8) to “1.” In this example, the microcomputer 14 may also count the pieces of audio music in descending order from the nth piece of audio music (Audio #n) to locate the seventh piece of audio music.

The microcomputer 14 then generates a random value with reference to the number (n−2) of the pieces of audio music other than the 5th and 8th pieces of audio music (Audio #5 and #8) whose play flags have been set to “1.” For example, when the generated random value is n−3, the microcomputer 14 counts the pieces of audio music sequentially from the 1st piece of audio music (Audio #1) to locate an n−3th piece of audio music while skipping the 5th and 8th pieces of audio music (Audio #5 and #8) whose play flags have been set to “1.” The microcomputer 14 then selects and plays an n−1th piece of audio music (Audio #n−1) corresponding to the n−3th piece of audio music located by skipping the 5th and 8th pieces of audio music (Audio #5 and #8) whose play flags have been set to “1,” and then sets a play flag of the n−1th piece of audio music (Audio #n−1) to “1.”

The microcomputer 14 then generates a random value with reference to the number (n−3) of the pieces of audio music other than the 5th, 8th, and n−1th pieces of audio music (Audio #5, #8, and #n−1) whose play flags have been set to “1.” For example, when the generated random value is 8, the microcomputer 14 counts the pieces of audio music sequentially from the 1st piece of audio music (Audio #1) to locate an eighth piece of audio music while skipping the 5th and 8th pieces of audio music (Audio #5 and #8) whose play flags have been set to “1.” The microcomputer 14 then selects and plays a 10th piece of audio music (Audio #10) corresponding to the eighth piece of audio music located by skipping the 5th and 8th pieces of audio music (Audio #5 and #8) whose play flags have been set to “1,” and then sets a play flag of the 10th piece of audio music (Audio #10) to “1.”

Thereafter, the microcomputer 14 plays a last piece of audio music (for example, a ninth piece of audio music (Audio #9)) whose play flag has not been set to “1” as shown in FIG. 4. When the last piece of audio music has been completely played, the microcomputer 14 clears the play flags of all pieces of audio music (Audio #1-#n) to “0” and again performs the above random play operation from the beginning. Further, in FIG. 3, a new play list is generated including an already played piece such that the last play list includes only one music piece. In FIG. 4, the length of the play list does not reduce or shrink, but rather the play flags for each piece is set to “1” when played.

Accordingly, in both examples, the number of random selection targets are gradually reduced, so that it is possible to more rapidly select a piece of audio music that has not yet been played and thus to more efficiently perform the random play operation.

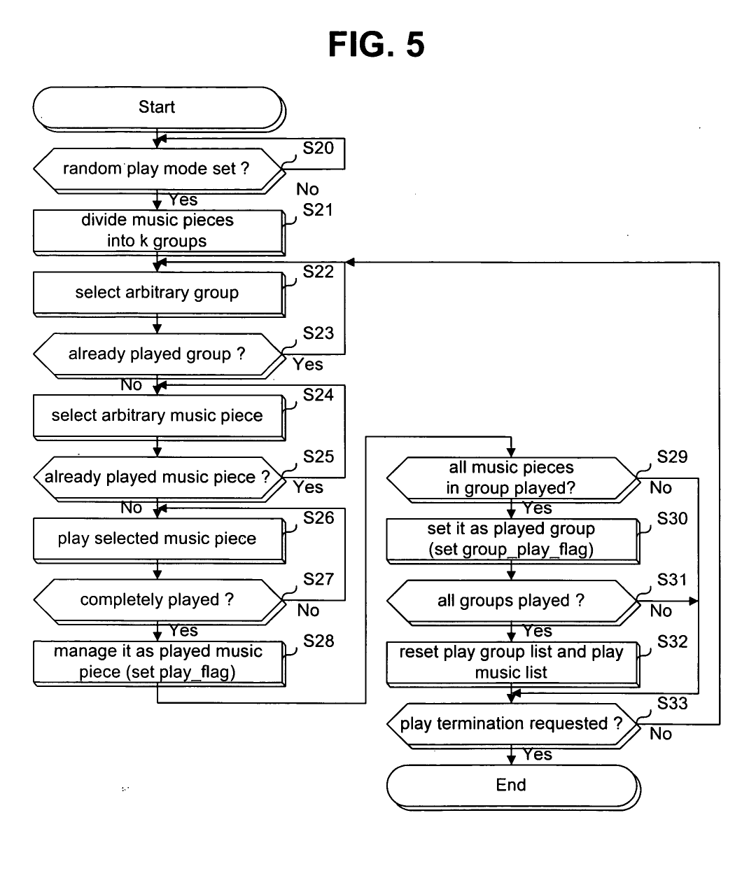

In a random play method according to another embodiment of the present invention, pieces of audio music which have been requested to be randomly played are divided into several groups. Further, a group is randomly selected from the detailed groups, and a piece of audio music is randomly selected from the selected group. A play flag is set for the selected and played piece of audio music so that it can be differentiated from a piece of audio music which has not been played. A group play flag is also set for a group in which all pieces of audio music have been played, so that it can be differentiated from a group in which any piece of audio music which has not been played remains. FIG. 5 is a flow chart of a random play method according to this embodiment of the present invention.

In more detail, referring to FIG. 5, when the user sets a random play mode for a number of titles (for example, n pieces of audio music) recorded on the optical disc 10 (S20), the microcomputer 14 of the audio player described above with reference to FIG. 1 divides the n pieces of audio music requested to be randomly played into k groups (Group #1-#k) (S21).

In this embodiment, the microcomputer 14 selects an arbitrary group and selects and plays an arbitrary piece of audio music in the selected group. The microcomputer 14 then sets a play flag “Play_Flag” of the played piece of audio music to “1” (S28), and sets a group play flag “Group_Play_Flag” of the group in which all pieces of audio music have been played to “1” (S30), and then manages the flags in the memory 15.

The microcomputer 14 also selects an arbitrary one of the k groups (Group #1-#k) (S22), and determines whether or not the selected group has been completely played based on a group play flag of the selected group managed in the memory 15 (S23). If the group play flag of the selected group has been set to “1” (Yes in S23), the microcomputer 14 again performs the above step S22 to select another group which has not been completely played.

Further, if it is determined that the selected group has not been played (No in S23), the microcomputer 14 selects an arbitrary piece of audio music in the selected group (S24), and determines whether or not the selected piece of audio music has already been played based on a play flag of the selected piece of audio music managed in the memory 15 (S25). If the play flag of the selected piece of audio music has been set to “1” (Yes in S25), the microcomputer 14 again performs the above step S24 to select another piece of audio music that has not been played in the selected group.

In addition, when the selected piece of audio music has been completely played (Yes in S27), the microcomputer 14 sets a play flag of the played piece of audio music to “1” and manages the play flag in the memory 15 (S28). The microcomputer 14 then determines whether or not all the pieces of audio music in the selected group have been played (S29). When the play flags of all the pieces of audio music in the selected group have been set to “1” (Yes in S29), the microcomputer 14 determines that the selected group has been completely played, sets the group play flag of the selected group to “1” and manages the group play flag in the memory 15 (S30).

Then, the microcomputer 14 determines whether or not all groups have been completely played based on the group play flags managed in the memory 15 (S31). If all of the groups have been completely played (Yes in S31), the microcomputer 14 clears all of the play flags and all of the group play flags, which have been set to “1” in the memory 15, to “0” (S32) to again perform the random play operation. Further, the random play operation is continued until the user requests that the play operation be terminated (S33).

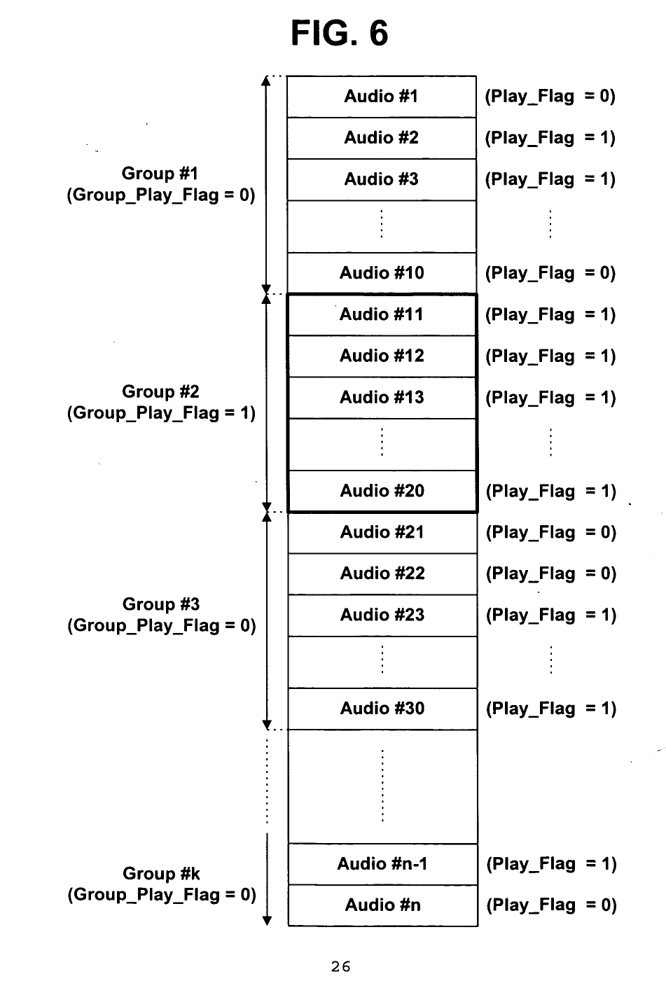

As discussed above, when performing a random play operation for n pieces of audio music (Audio #1-#n) recorded on the optical disc 10, the microcomputer 14 divides the n pieces of audio music into k groups (Group #1-#k), each having, for example, 10 pieces of audio music as shown in FIG. 6. In more detail, the microcomputer 14 first randomly selects a 2nd piece of audio music (Audio #2) in a 1st one of the k groups as a first piece of audio music to play, plays the selected 2nd piece of audio music, and then sets a play flag of the 2nd audio music (Audio #2) to “1” and manages the play flag in the memory 15.

The microcomputer 14 then performs a series of operations for randomly selecting and playing a 23rd piece of audio music (Audio #23) in a 3rd one of the k groups as a second piece of audio music to play and sets a play flag of the 23rd audio music (Audio #23) to “1.” Pieces of audio music that have already been played are filtered out through their play flags managed in the memory 15.

When all of the pieces of audio music (Audio #11-#20) in the second group (Group #2) have been played as shown in FIG. 6 during the above operations, the microcomputer 14 sets a group play flag (Group_Play_Flag) assigned to the second group to “1” and manages the set group play flag in the memory 15. Groups that have already been played are filtered out through their group play flags managed in the memory 15.

When all group play flags assigned to the remaining groups have been set to “1” via the above series of operations, the microcomputer 14 clears all group play flags and all play flags assigned to the pieces of audio music to “0,” and again performs the above audio random play operation. Further, when a large number of titles are present and thus a large number of divided groups are present, the groups may also be divided into higher-level groups so the titles are managed in a plurality of levels of groups.

In the embodiment of FIG. 5, a group and/or a piece of audio music in each group may also be selected in the following manner. That is, a random value is generated with reference to the number of groups and/or pieces of audio music that have not yet been played other than groups and/or pieces of audio music that have already been played, as in the embodiment of FIG. 2, and a group and/or a piece of audio music corresponding to the generated random value is selected as in the embodiment of FIG. 4.

Thus, the group-based random selection operation efficiently reduces the number of selection targets, so it is possible to more efficiently and rapidly perform the random play operation.

As is apparent from the above description, a random play method according to an embodiment of the present invention reduces the number of random selection targets so that it is possible to rapidly select a title that has not yet been played and thus to perform an efficient random play operation.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A random play method comprising:
selecting an arbitrary file to be played from a playlist;
playing the arbitrary file; and
selecting a next arbitrary file to be played from the playlist while skipping the played arbitrary file until all files in the playlist have been played.

2. The method of claim 1, further comprising:
setting a play flag of the played arbitrary file to a value indicating the file has been played,
wherein selecting the next arbitrary file to be played from the playlist selects only an arbitrary file not having a play flag set to indicate the file has been played.

3. The method of claim 2, further comprising:
dividing the playlist into a plurality of groups.

4. The method of claim 3, wherein selecting the arbitrary file selects an arbitrary file in one of the plurality of groups.

5. The method of claim 4, further comprising:
setting a group play flag to a value indicating all files in the group have been played when all files in the group have been played,
wherein selecting the next arbitrary file to be played from the playlist selects only an arbitrary file from a group not having a group play flag set to the value indicating all files in the group have been played.

6. The method of claim 2, further comprising:
resetting the set play flags for all files in the playlist when all the files in the playlist have been completely played.

7. The method of claim 5, further comprising:
resetting the set group play flags for all groups in the playlist when all the files in each group of the playlist have been completely played.

8. A random play apparatus, comprising:
a controller configured to select an arbitrary file to be played from a playlist; and
a decoder configured to play the arbitrary file,
wherein the controller selects a next arbitrary file to be played from the playlist while skipping the played arbitrary file until all files in the playlist have been played.

9. The apparatus of claim 8, wherein the controller sets a play flag of the played arbitrary file to a value indicating the file has been played, and selects only an arbitrary file not having a play flag set to indicate the file has been played.

10. The apparatus of claim 9, wherein the controller divides the playlist into a plurality of groups.

11. The apparatus of claim 10, wherein the controller selects an arbitrary file in one of the plurality of groups.

12. The apparatus of claim 11, wherein the controller sets a group play flag to a value indicating all files in the group have been played when all files in the group have been played, and selects only an arbitrary file from a group not having a group play flag set to the value indicating all files in the group have been played.

13. The apparatus of claim 9, wherein the controller resets the set play flags for all files in the playlist when all the files in the playlist have been completely played.

14. The apparatus of claim 12, wherein the controller resets the set group play flags for all groups in the playlist when all the files in each group of the playlist have been completely played.

15. A random play method comprising:
generating a first playlist of files to be played;
playing an arbitrary file among the first playlist; and
generating a new playlist excluding the played arbitrary file.

16. The method of claim 15, wherein the playlist includes a smaller number of files than the first playlist.

17. The method of claim 15, wherein generating the new playlist consecutively generates a new playlist until only one file remains in the playlist.

18. The method of claim 15, further comprising:
selecting an arbitrary file to be played from the playlist;
playing the arbitrary file; and
selecting a next arbitrary file to be played from the new playlist.

19. The method of claim 18, further comprising:
setting a play flag of the played arbitrary file to a value indicating the file has been played,
wherein selecting the next arbitrary file to be played from the another playlist selects an arbitrary file not having a play flag set to indicate the file has been played.

20. A random play apparatus, comprising:
a controller configured to generate a first playlist of files to be played; and
a decoder configured to play an arbitrary file among the first playlist,
wherein the controller generates a new playlist excluding the played arbitrary file.

21. The apparatus of claim 20, wherein the second playlist includes a smaller number of files than the first playlist.

22. The apparatus of claim 20, wherein the controller consecutively generates a new playlist until only one file remains in the playlist.

23. The apparatus of claim 20, wherein the controller selects an arbitrary file to be played from the playlist, the decoder plays the arbitrary file, and the controller selects a next arbitrary file to be played from the new playlist.

24. The apparatus of claim 23, wherein the controller sets a play flag of the played arbitrary file to a value indicating the file has been played, and selects the next arbitrary file to be played from the another playlist selects an arbitrary file not having a play flag set to indicate the file has been played.
